(19) United States
(12) Patent Application Publication
(10) Pub. No.: US 2019/0045362 A1
(43) Pub. Date: Feb. 7, 2019

(54) Enhanced GPRS Integrity Bit And Cross-Layer Indications

(71) Applicant: Telefonaktiebolaget LM Ericsson (publ), Stockholm (SE)

(72) Inventors: Vesa Torvinen, Sauvo (FI); Yasir Hussain, Solna (SE); Nicklas Johansson, Brokind (SE); Paul Schliwa-Bertling, Ljungsbro (SE); Mikael Wass, Sätila (SE); Monica Wifvesson, Lund (SE)

(21) Appl. No.: 16/071,986

(22) PCT Filed: Nov. 25, 2016
(86) PCT No.: PCT/EP2016/078893

§ 371 Date: Jul. 23, 2018

Related U.S. Application Data
(60) Provisional application No. 62/286,733, filed on Jan. 25, 2016.

(51) Int. Cl. H04W 12/10; H04L 29/06

(52) U.S. Cl. CPC H04W 12/10; H04W 4/70; H04L 63/20; H04L 63/123

(57) ABSTRACT

An electronic communication device of a telecommunications system receives a message containing an integrity mode bit and an integrity protection bit from another electronic communication device, and determines whether the integrity protection bit indicates that a Frame Check Sequence, FCS, field of the message has been replaced by a Medium Access Control, MAC, field. Responsive to determining that the integrity protection bit indicates that the FCS field has been replaced by the MAC field, the device determines whether the MAC field is valid. Responsive to determining that the MAC field is not valid and the integrity mode bit having a first defined value, the message is discarded. Responsive to determining that the MAC field is not valid and the integrity mode bit having a second defined value, content of the message is provided to a higher network protocol layer for processing.

### CROSS REFERENCE TO RELATED APPLICATION

The present Application claims the benefit of priority from U.S. Provisional Application No. 62/286,733 filed Jan. 25, 2016, the disclosure of which is hereby incorporated herein in its entirety by reference.

### TECHNICAL FIELD

The present disclosure relates to methods and operations by network nodes and user equipments in a telecommunications system.

### BACKGROUND

Cellular Internet of Things (CIoT) is a new radio technology that is able to provide extended coverage for harsh environments (e.g. building basements), and is supposed to serve massive number of UEs (User Equipment nodes), e.g., over 50,000 UEs per base station, using a very limited bandwidth (e.g. 160 bps).

The current assumption in 3GPP standardization is that the security mechanism for CIoT over GERAN (GSM/EDGE Radio Access Network) would be based on enhancements of GPRS (General Packet Radio Service) security as introducing integrity protection for the control plane in Gb mode between the CIoT UE and the SGSN (Serving GPRS Support Node).

The assumption for CIoT is that UMTS AKA (Universal Mobile Telecommunications System Authentication and Key Agreement) is run at GMM/SM (GPRS Mobility Management/Session Management) layer creating the keying material, and the integrity protection is done at LLC (Logical Link Control) layer using the integrity key (IK') created with the key derivation function from the UMTS (Universal Mobile Telecommunications System) AKA (Authentication and Key Agreement) session keys.

FIG. 1 illustrates an enhanced control plane for communications between a CIoT UE 100 and a SGSN 120 which communicate in Gb mode. The Gb interface communicatively connects the BSS (Base Station Subsystem) 110 and the SGSN 120 for exchange of signaling information and user data. The BSS 110 operates as a part of a GERAN providing the allocation, release and management of specific radio resources to establish communication connection between a UE 100 and the GERAN.

Encryption is supported by the LLC layer in GPRS since 3GPP Release 99 (R99) and it is expected that this feature is reused for CIoT.

The protocol details related to integrity algorithms are currently under discussion in 3GPP Working Group SA3 and 3GPP Working Group CT1. One of the protocol proposals is to replace the current FCS (Frame Check Sequence) field with a MAC (Medium Access Control). However, CT1 has commented that both should be added.

In existing approaches, the Frame Check Sequence (FCS) Field is a 24 bits long CRC (cyclic redundancy check). It is used in GPRS to identify bit errors that are caused by the transport. The FCS field is able to identify bit errors; however, it cannot be used to identify where exactly the bit errors occur, or to fix the errors. Messages with invalid FCS field need to be re-transmitted. It is noted that the FCS is not the only error checking CRC in GPRS. The radio network (MS to BSS) also provide an error checking and re-transmission function at the lower layers (RLC/MAC (Radio Link Control/Medium Access Control)). The CRC code at lower layers is 8 bits long.

In addition to normal “protected mode” (with re-transmissions), the UI-frames that are sent in “unprotected mode” can be delivered to the upper layer protocol even if the FCS field was invalid. This is useful e.g. for streaming applications which are able to handle the bit errors. This type of functionality would be required for GMM (GPRS Mobility Management) messages that are “conditionally integrity protected”. These messages can include GMM ATTACH REQUEST or GMM ROUTING AREA UPDATE REQUEST, and can be sent over existing security association but would still need to be processed at the GMM layer if the MAC verification failed.

FIG. 2 illustrates which fields of a legacy LLC message are used for FCS field calculation and which fields are confidentiality protected. It is noted that the FCS field is not currently protected against modification, and is sometimes sent in cleartext.

With UI frames, the use of the “unprotected” or “protected” mode is indicated in the message by a Protection Mode (PM) bit. If the PM bit is logical 0, the message is delivered to the upper layer for processing even if the FCS failed. FIG. 3 is a table that illustrates PM and E logical values and the corresponding meaning in the UI frame information field.

The approaches described in the Background section could be pursued, but are not necessarily approaches that have been previously conceived or pursued. Therefore, unless otherwise indicated herein, the approaches described in the Background section are not prior art to the claims in this application and are not admitted to be prior art by inclusion in the Background section.

### SUMMARY

Some embodiments disclosed herein are directed to a method performed by a electronic communication device of a telecommunications system. The method includes receiving a message containing an integrity mode bit and an integrity protection bit from another electronic communication device and determining whether the integrity protection bit indicates that a Frame Check Sequence, FCS, field of the message has been replaced by a Medium Access Control, MAC, field. Responsive to determining that the integrity protection bit indicates that the FCS field has been replaced by the MAC field, the method includes determining whether the MAC field is valid. Responsive to determining that the MAC field is not valid and the integrity mode bit having a first defined value, the message is discarded. Responsive to determining that the MAC field is not valid and the integrity mode bit has a second defined value, providing content of the message to a higher network protocol layer for processing.

Potential advantages of these operational embodiments can include that they minimize the amount of changes to LLC protocol when integrity protection is added. For example, the embodiments may obsolete the use of a FCS field (and related protected and unprotected modes) if integrity protection is used with GPRS. The embodiments may result in no need to carry both FCS field and MAC in the same message. This may be particularly important if integrity protection is used to protect user data, or if the UE has limitations in the battery or processing capabilities. The embodiments may result in no need to specify behavior related to FCS/MAC processing at the same time, which results in a reduced complexity operational protocol.

In some further embodiments, determining whether the integrity protection bit indicates that a FCS field has been replaced by a MAC field may include determining that the FCS field has been replaced by the MAC field responsive to the integrity protection bit being logic 1. The integrity protection bit may indicate whether a 3 octet long FCS field has been replaced by a 4 octet long MAC field. The operations may include determining a location of the integrity mode bit in the message based on a defined location where a protection mode bit is contained in another message receivable by the electronic communication device from the other electronic communication device. The first defined value may be logic 1 and the second defined value may be logic 0.

In some further embodiments, determining whether the integrity protection bit indicates that a FCS field has been replaced by a MAC field and the determining whether the MAC field is valid may both be performed by a Layer 3 of a OSI network protocol stack of the electronic communication device. Providing content of the message to a higher network protocol layer may include providing the content of the message to a higher layer of the OSI network protocol stack.

The higher layer of the OSI network protocol stack may be Layer 4. The electronic communication device may include a user equipment. The electronic communication device may include a Serving GPRS Support Node. An electronic communication device may be configured to perform the steps of the method described herein.

Some other embodiments are directed to an electronic communication device of a telecommunications system. The electronic communication system may include a receiver configured to receive a message containing an integrity mode bit and an integrity protection bit from another electronic communication device. The electronic communication system may include a processor connected to the receiver and configured to determine whether the integrity protection bit indicates that a Frame Check Sequence (FCS) field has been replaced by a Medium Access Control (MAC) field. Responsive to determining that the integrity protection bit indicates that the FCS field has been replaced by the MAC field, the processor may determine whether the MAC field is valid. Responsive to determining that the MAC field is not valid and the integrity mode bit having a first defined value, the processor may discard the message. Responsive to determining that the MAC field is not valid and the integrity mode bit having a second defined value, the processor may provide content of the message to a higher network protocol layer for processing.

In some further embodiments, determining whether the integrity protection bit indicates that a FCS field has been replaced by a MAC field, may include determining that the FCS field has been replaced by the MAC field responsive to the integrity protection bit being logic 1.

The integrity protection bit may indicate whether a 3 octet long FCS field has been replaced by a 4 octet long MAC field. The processor may be further configured to determine a location of the integrity mode bit in the message based on a defined location where a protection mode bit is contained in another message receivable by the electronic communication device from the other electronic communication device. The first defined value may logic 1 and the second defined value may be logic 0.

In some further embodiments, determining whether the integrity protection bit indicates that a FCS field has been replaced by a MAC field and the determining whether the MAC field is valid may be both performed by a Layer 3 of a OSI network protocol stack of the electronic communication device. Providing content of the message to a higher network protocol layer, may include providing the content of the message to a higher layer of the OSI network protocol stack. The higher layer of the OSI network protocol stack may be Layer 4. The electronic communication device may include a user equipment. The electronic communication device may include a Serving GPRS Support Node.

Some other embodiments are directed to a method by an electronic communication device of a telecommunications system. The method includes generating a message containing an integrity mode bit and an integrity protection bit, wherein the integrity protection bit indicates whether a Frame Check Sequence, FCS, field of the message has been replaced by a Medium Access Control, MAC, field, and the integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid, and communicating the message toward the other electronic communication device through the telecommunications system.

In some embodiments, the integrity protection bit may be set to logic 1 to indicate that the FCS field has been replaced by the MAC field. The integrity protection bit may indicate whether a 3 octet long FCS field has been replaced by a 4 octet long MAC field. Generating the message may include defining a value of the integrity mode bit at a location in the message that corresponds to a location where a protection mode bit is contained in another message communicated to the other electronic communication device. The first defined value may logic 1 and the second defined value may be logic 0. The electronic communication device may include a user equipment. The electronic communication device may include a Serving GPRS Support Node.

Some other embodiments are directed to an electronic communication device of a telecommunications system. The electronic communication device may include a network interface configured to communicate message toward another electronic communication device through the telecommunications system, and a processor connected to the network interface. The processor may be configured to generate a message containing an integrity mode bit and an integrity protection bit, wherein the integrity protection bit indicates whether a Frame Check Sequence (FCS) field of the message has been replaced by a Medium Access Control (MAC) field, and the integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid, and communicate the message through the network interface toward the other electronic communication device.

In some embodiments, the processor sets the integrity protection bit to logic 1 to indicate that the FCS field has been replaced by the MAC field. The integrity protection bit indicates whether a 3 octet long FCS field has been replaced by a 4 octet long MAC field. Generating the message may include defining a value of the integrity mode bit at a location in the message that corresponds to a location where a protection mode bit is contained in another message communicated to the other electronic communication device. The first defined value may logic 1 and the second defined value may be logic 0. The electronic communication device may include a user equipment. The electronic communication device may include a Serving GPRS Support Node.

Some other embodiments are directed to an electronic communication device of a telecommunications system. The electronic communication device may include a receiver module configured to receive a message containing an integrity mode bit and an integrity protection bit from another electronic communication device, an integrity protection bit determining module configured to determine whether the integrity protection bit indicates that a Frame Check Sequence, FCS, field of the message has been replaced by a Medium Access Control, MAC, field. Responsive to determining that the integrity protection bit indicates that the FCS field has been replaced by the MAC field, a MAC field validity determination module may be configured to determine whether the MAC field is valid. An integrity mode bit determining module may be configured to, responsive to determining that the MAC field is not valid and the integrity mode bit having a first defined value, discard the message. A message layer routing module may be configured to, responsive to determining that the MAC field is not valid and the integrity mode bit having a second defined value, provide content of the message to a higher network protocol layer for processing.

Some other embodiments are directed to an electronic communication device of a telecommunications system. The electronic communication device may include a message generation module configured to generate a message containing an integrity mode bit and an integrity protection bit. The integrity protection bit may indicate whether a Frame Check Sequence, FCS, field of the message has been replaced by a Medium Access Control, MAC, field, and the integrity mode bit may indicate whether another electronic communication device receiving the message is to discard the message responsive to determining that the MAC field is not valid or is to provide content of the message to a higher network protocol layer of the another electronic communication device for processing responsive to determining that the MAC field is not valid. A message communication module may be configured to communicate the message toward the other electronic communication device through the telecommunications system.

Other methods by UEs, UEs, methods by network nodes, and network nodes according to embodiments will be or become apparent to one with skill in the art upon review of the following drawings and detailed description. It is intended that all such additional methods, resource management computer nodes, and/or computer program products be included within this description and protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 illustrates an enhanced control plane for communications between a CIoT UE and a SGSN which communicate in Gb mode;

FIG. 2 illustrates which fields of a legacy LLC message are used for FCS field calculation and which fields are confidentiality protected;

FIG. 3 is a table that illustrates PM and E logical values and the corresponding meaning in the UI frame information field;

FIG. 4 illustrates a LLC message format that is used when integrity protection is to be provided, in accordance with some embodiments of the present disclosure;

FIG. 5 illustrates certain control bits (e.g., I and IM bits) that can be included in a message for integrity protection in accordance with some embodiments of the present disclosure;

FIG. 6 is a table that illustrates how the new IM bit and the existing encryption (E) are related to each other by the UI frame information field in accordance with some embodiments;

FIG. 7 illustrates methods and operations that can be performed by an electronic communication device of a telecommunications system in accordance with some embodiments;

FIG. 8 illustrates methods and operations that can be performed by an electronic communication device of a telecommunications system in accordance with some embodiments;

FIG. 9 is a block diagram of a UE, for use in a telecommunications system, that is configured to perform operations according to one or more embodiments disclosed herein;

FIG. 10 is a block diagram of a network node, for use in a telecommunications system, that is configured according to one or more embodiments disclosed herein for a network node;

FIG. 11 illustrates modules residing in an electronic communication device that receives message from another electronic communication device, and that perform operations as disclosed herein according to some embodiments; and

FIG. 12 illustrates modules residing in an electronic communication device that communicates message to another electronic communication device, and that perform operations as disclosed herein according to some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment. Any two or more embodiments described below may be combined in any way with each other.

Various embodiments of the present disclosure are directed to methods and operations in a UE and a network node that replace the current FCS field with a new MAC (Medium Access Control) signal. This approach can be beneficial because the FCS field and the MAC have overlapping functionality, and both of them can fail if there is a bit error in the message. The FCS field itself does not assist the SGSN with processing a message if the MAC fails. Moreover, when the MAC fails, the FCS might fail. The functionality that is needed is actually the “unprotected mode” where also the erroneous frames are delivered to the upper layer. This has very little to do with the FCS field itself.

If, in contrast to at least some of the present embodiments, the FCS field and MAC were used, the SA3 and CT1 would need to specify functionality to all four cases of correct and erroneous fields (i.e., correct/erroneous FCS versus correct/erroneous MAC). If the integrity protection is also used with the user plane, then SA3 should try to avoid adding any overload if possible. However, using both FCS and MAC in a message adds to such overload. If only MAC was used, all messages would need to be delivered to the upper layer even if the integrity failed. This is not practical because the layer 3 protocol could become overloaded.

In accordance with various embodiments disclosed herein, the current FCS field is replaced with a new MAC signal. These embodiments add a new “Integrity Mode” to the communication protocol. A receiving device operating in the integrity mode performs different operations to process a received package depending upon whether the checking of the code (i.e., FCS field in legacy GPRS, and MAC in enhanced GPRS) results in a determination of failure. A determination of failure from checking of the code can result in the package being dropping or delivery of the package to a higher level for processing (e.g., by a user application layer) with an “integrity failed” indication. These embodiments can add cross-layer indicators related to the new “Integrity Mode” operation.

Potential advantages of these operational embodiments can include that they minimize the amount of changes to LLC protocol when integrity protection is added. For example, the embodiments may obsolete the use of a FCS field (and related protected and unprotected modes) if integrity protection is used with GPRS. The embodiments may result in no need to carry both FCS field and MAC in the same message, which can be particularly important if integrity protection is used to protect user data, or if the UE has limitations in the battery or processing capabilities. The embodiments may result in no need to specify behavior related to FCS/MAC processing at the same time (e.g., 2×2=4 different combinations of successful or failing codes), which results in a reduced complexity operational protocol.

These operational embodiments can improve control plane and user plane integrity, and provide a way to implement integrity protection at LLC protocol. The embodiments can assume that once integrity protection has been turned on, there is an integrity protection indication bit in the control field of the LLC message that allows the receiving device to know that the message does not contain a 3 octet long FCS field but instead contains a 4 octet long MAC field.

These operational embodiments can follow similar operations to NAS security where the ciphering of the information field is performed first, and the MAC is calculated over the cleartext address and control fields, and the ciphered information field. FIG. 4 illustrates a LLC message format that is used when integrity protection is to be provided, in accordance with some embodiments of the present disclosure.

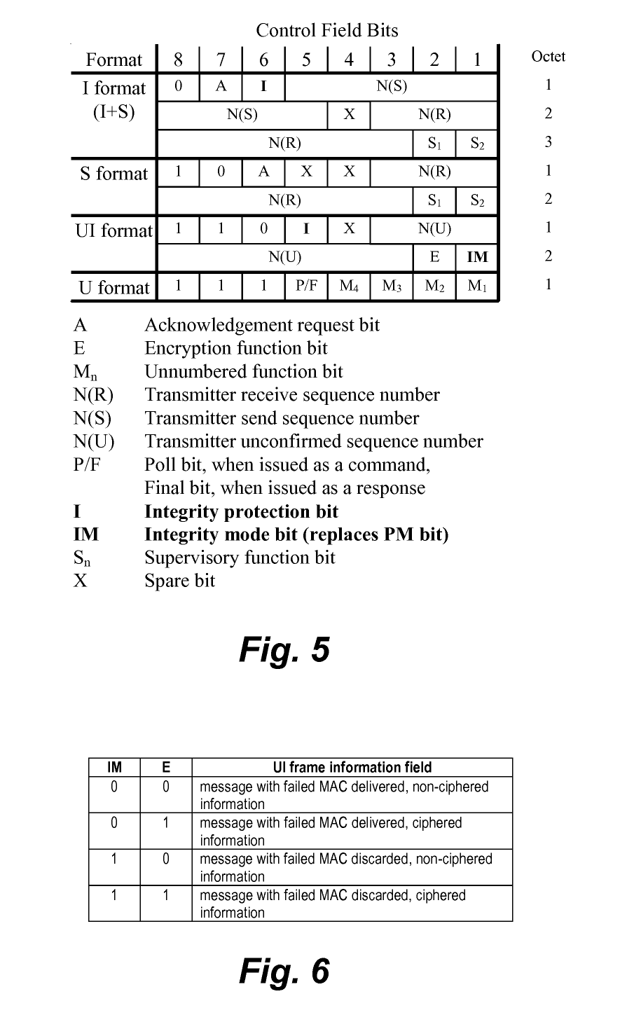

In order to provide operational functionality where messages with erroneous FCS fields are delivered to the upper layer (network processing layer), the control field of UI frames is enhanced by adding a new Integrity Mode (IM) bit as content. The control field bits also include the integrity protection (I) bit which indicates whether integrity protection is in use, and the FCS field is replaced by MAC. FIG. 5 illustrates certain control bits (e.g., I and IM bits) that can be included in a message for integrity protection in accordance with some embodiments of the present disclosure.

In accordance with some embodiments, when integrity protection is being used (i.e., active) by a transmitting device and a receiving device, an integrity protection bit (I) is set to a defined value to indicate that the three octets long FCS field has been replaced by a four octets long MAC. More generally, when integrity protection is being use (i.e., active), the integrity protection bit (I) is set to a defined value to indicate that all or a defined portion of the FCS field has been replaced by a defined bit length MAC.

In one embodiment, the integrity protection “I” bit is set to logic 1 to indicate the presence of a four octets long MAC in a message, and, correspondingly, indicate that the FCS field is not present in the message. In other words, the receiving device interprets the “I” bit being logic 1 as an indication that a four octets long MAC is contained in a receiving message, and responsively processes the MAC at a location in the message that can be determined by the receiving device based on where the FCS field would have been located. In at least one embodiment, an “I” bit value of logic 0 is not used to indicate an operational decision to the receiving device.

In accordance with some embodiments, when integrity protection is being used (i.e., active) by a transmitting device and a receiving device, an Integrity Mode (IM) bit in included in a message to control operation of the LLC layer at the receiving device based on whether the MAC verification fails. In at least one embodiment, the IM bit replaces the PM (Protection Mode) bit in content of a legacy UI frame.

In one embodiment, the IM bit is set to logic 1 to indicate to the receiving device that in the case of MAC verification failure, the receiving device is to operate to discard the message and correspondingly not deliver the message to the upper layer.

In one embodiment, the IM bit is set to logic 0 to indicate to the receiving device that in the case of MAC verification failure, the receiving device is to not discard the message but instead provide the message to the upper layer, e.g., for processing of the message payload (e.g., user data). The LLC layer indicates to the upper layer that the integrity protection failed (i.e., MAC verification failure).

FIG. 6 is a table that illustrates how the new IM bit and the existing encryption (E) are related to each other by the UI frame information field in accordance with some embodiments.

LLC (Logical Link Control) primitives are used by the Layer 3 to request the LLC protocol for transmission of a L3-PDU (Protocol Data Unit). These primitives can be enhanced to include indications of whether the message needs to be integrity protected or not. If the request is about unconfirmed transmission, the integrity mode is also indicated in the request.

LLC primitives can also be used by the LLC protocol to deliver the received L3-PDU to layer 3. These primitives can be enhanced to include indications of whether the message was integrity protected or not. If the L3-PDU is received as an unconfirmed transmission using the integrity mode that allows the delivery of a message with a failed MAC, the indication tells whether the verification of the MAC failed or was successful.

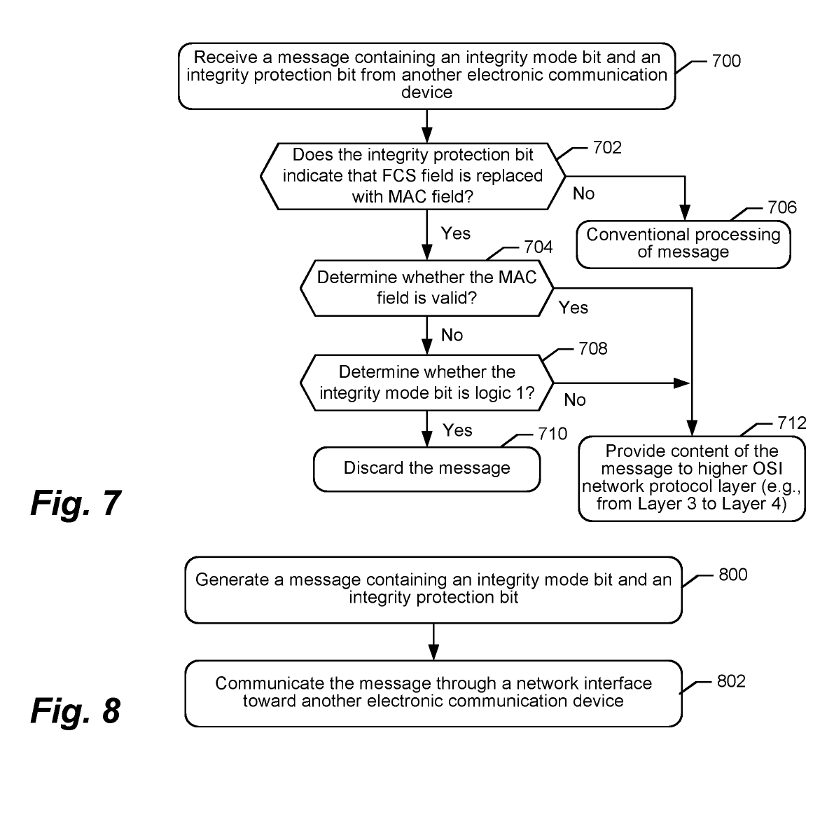

FIG. 7 illustrates methods and operations that can be performed by an electronic communication device of a telecommunications system in accordance with some embodiments. Referring to FIG. 7, a message containing an integrity mode bit and an integrity protection bit is received (block 700) which from another electronic communication device.

The electronic communication device can be a user equipment and/or a Serving GPRS Support Node, although the electronic communication device may be any type of communication device. Accordingly, when the electronic communication device is a UE the other electronic communication device may be a SGSN, or vice versa.

A determination (block 702) is performed whether the integrity protection bit indicates that a Frame Check Sequence (FCS) field of the message has been replaced by a Medium Access Control (MAC) field. Responsive to determining that the integrity protection bit indicates that the FCS field has not been replaced by the MAC field, conventional processing operations can be performed (block 706) on the message.

In sharp contrast, responsive to determining that the integrity protection bit indicates that the FCS field has been replaced by the MAC field, a further determination (block 704) is made whether the MAC field is valid. Responsive to determining that the MAC field is valid, content of the message may be provided (block 712) to a higher network protocol layer for processing.

Responsive to determining that the MAC field is not valid and the integrity mode bit is determined (block 708) to have a first defined value (e.g., logic 1), the message is discarded (block 710). Responsive to determining that the MAC field is not valid and the integrity mode bit being determined (block 708) to have a second defined value (e.g., logic 0), content of the message is provided (block 712) to a higher network protocol layer for processing.

In one embodiment, the integrity protection bit has a logic 1 value to indicate that the FCS field has been replaced by the MAC field. The integrity protection bit can indicate whether a 3 octet long FCS field has been replaced by a 4 octet long MAC field.

The electronic communication device can determine a location of the integrity mode bit in the message based on a defined location where a protection mode bit is contained in another message receivable by the electronic communication device from the other electronic communication device.

In some embodiments, the determination (block 702) of whether the integrity protection bit indicates that a FCS field has been replaced by a MAC field and the determination (block 704) whether the MAC field is valid are both performed by a Layer 3 of a OSI network protocol stack of the electronic communication device. When providing (block 712) content of the message to a higher network protocol layer for processing, the electronic communication device can provide the content of the message to a higher layer (e.g., Layer 4) of the OSI network protocol stack

FIG. 8 illustrates methods and operations that can be performed by an electronic communication device of a telecommunications system in accordance with some embodiments. Referring to FIG. 8, a message is generated (block 800) to contain an integrity mode bit and an integrity protection bit. The integrity protection bit indicates whether a Frame Check Sequence (FCS) field of the message has been replaced by a Medium Access Control (MAC) field. The integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid. The electronic communication device communicates (block 802) the message toward the other electronic communication device through the telecommunications system.

The integrity protection bit can be set to logic 1 to indicate that the FCS field has been replaced by the MAC field. The integrity protection bit can indicate whether a 3 octet long FCS field has been replaced by a 4 octet long MAC field.

Generation of the message can include defining a value of the integrity mode bit at a location in the message that corresponds to a location where a protection mode bit is contained in another message communicated to the other electronic communication device. The first defined value can be logic 1 and the second defined value can be logic 0.

The electronic communication device may be a user equipment and/or a Serving GPRS Support Node.

Various embodiments have been described herein using a non-limiting term UE. The term UE used herein can be any type of wireless device capable of communicating with a network node, such as a base station, or another UE over radio signals. The UE may also be a radio communication device, target device, device to device (D2D) UE, machine type UE or UE capable of machine to machine communication (M2M), a sensor equipped with UE, iPAD, Tablet, mobile terminals, smart phone, laptop embedded equipped (LEE), laptop mounted equipment (LME), USB dongles, Customer Premises Equipment (CPE), etc.

### Example User Equipment and Network Node

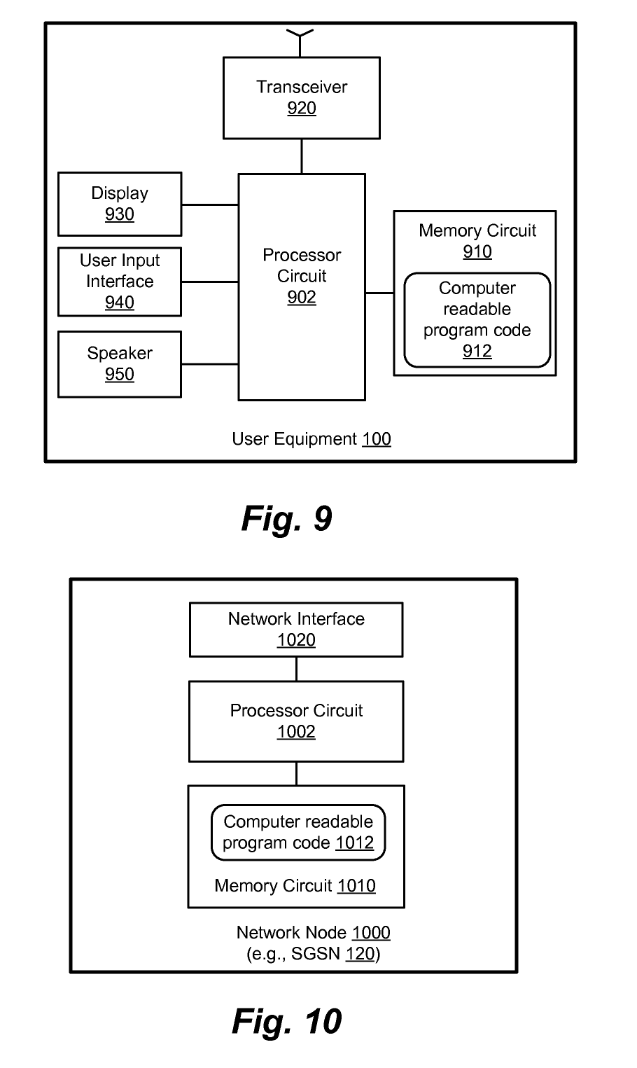

FIG. 9 is a block diagram of a UE 100, for use in a telecommunications system, that is configured to perform operations according to one or more embodiments disclosed herein. The UE 100 includes a transceiver 920, a processor circuit 902, and a memory circuit 910 containing computer readable program code 912. The UE 100 may further include a display 930, a user input interface 940, and a speaker 950.

The transceiver 920 is configured to communicate with network nodes and may communicate with other UEs, through a wireless air interface using one or more of the radio access technologies disclosed herein. The processor circuit 902 may include one or more data processing circuits, such as a general purpose and/or special purpose processor, e.g., microprocessor and/or digital signal processor. The processor circuit 902 is configured to execute the computer readable program code 912 in the memory circuit 910 to perform at least some of the operations described herein as being performed by a UE.

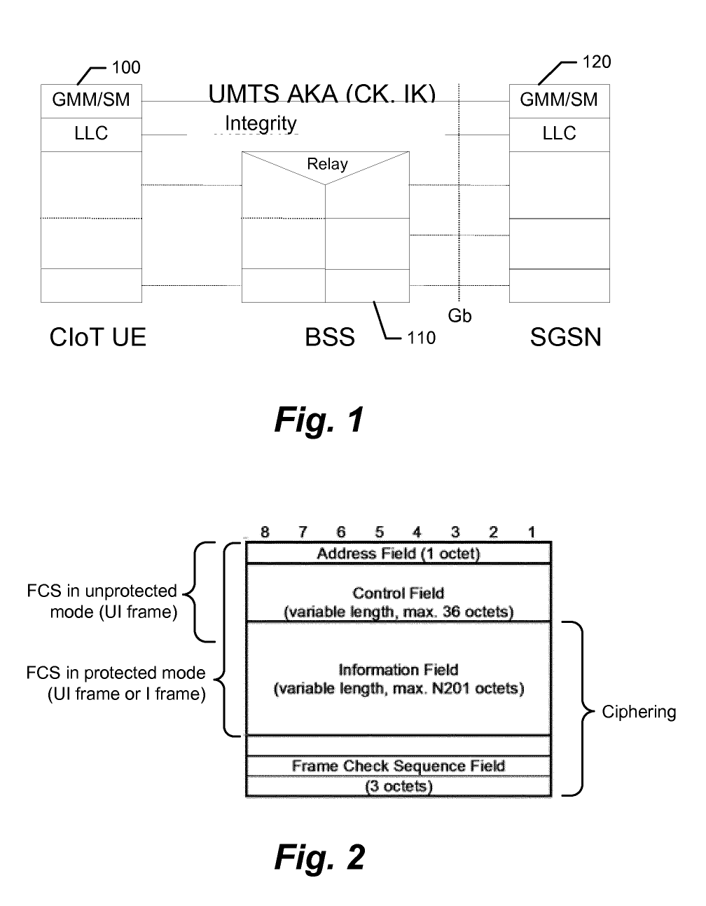

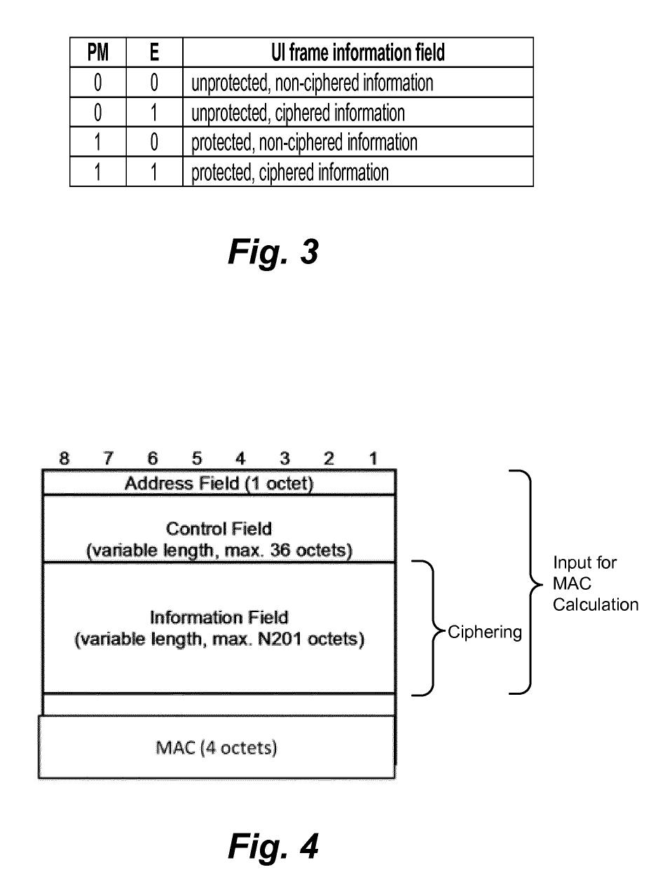

FIG. 10 is a block diagram of a network node 1000, for use in a telecommunications system, that is configured according to one or more embodiments disclosed herein for a network node. The network node 1000 may correspond to the SGSN 120 shown in FIG. 1 and/or may correspond to any other network node of a telecommunications system configured according to at least one embodiment disclosed herein. The network node 1000 can include a network interface 1020 (e.g., wired network interface and/or wireless transceiver), a processor circuit 1002, and a memory circuit 1010 containing computer readable program code 1012.

The processor circuit 1002 may include one or more data processing circuits, such as a general purpose and/or special purpose processor, e.g., microprocessor and/or digital signal processor, that may be collocated or distributed across one or more networks. The processor circuit 1002 is configured to execute the computer readable program code 1012 in the memory 1010 to perform at least some of the operations and methods of described herein as being performed by a network node. The network interface 1020 communicates with a UE, another network node, and/or a core network.

### Example Modules in an Electronic Communication Device

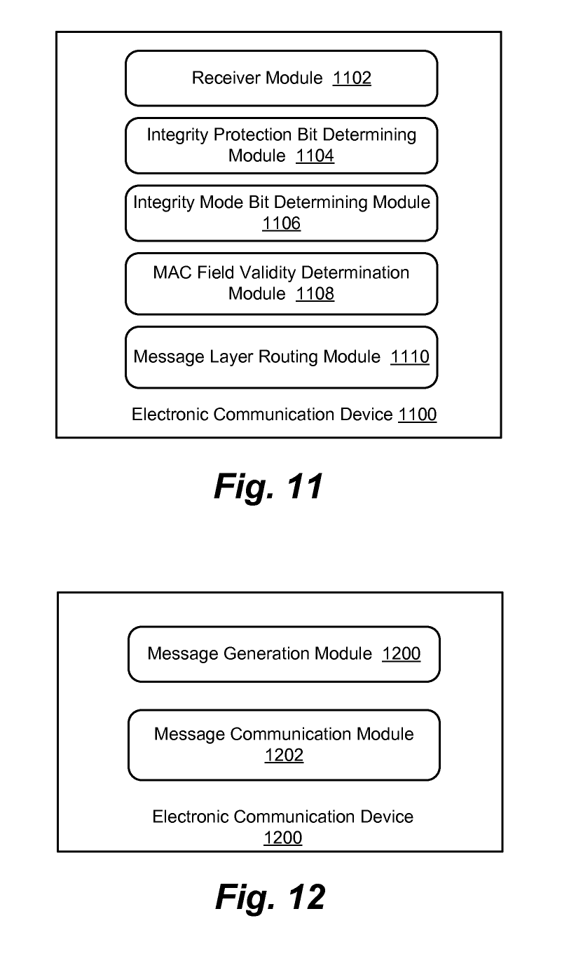

FIG. 11 illustrates modules residing in an electronic communication device 1100 (e.g., UE or SGSN) that receives message from another electronic communication device (e.g., SGSN or UE), and that perform operations as disclosed herein according to some embodiments. The electronic communication device 1100 includes a receiver module 1102, an integrity protection bit determining module 1104, an integrity mode bit determining module 1106, a MAC field validity determination module 1108, and a message layer routing module 1110. The receiver module 1102 receives a message containing an integrity mode bit and an integrity protection bit from another electronic communication device. The integrity protection bit determining module 1104 determines whether the integrity protection bit indicates that a Frame Check Sequence (FCS) field of the message has been replaced by a Medium Access Control (MAC) field. The integrity mode bit determining module 1106 determines whether the integrity mode bit contained in the message has a first defined value (e.g., logic 0) or a second defined value (e.g., logic 1). The MAC field validity determination module 1108 determines whether the MAC field is valid. The message layer routing module 1110 responds to a determination that the MAC field is not valid and the integrity mode bit has a first defined value, by discarding the message. In contrast, the message layer routing module 1110 responds to a determination that the MAC field is not valid and the integrity mode bit has a second defined value, by providing content of the message to a higher network protocol layer for processing (e.g., from Layer 3 to Layer 4).

FIG. 12 illustrates modules residing in an electronic communication device 1200 (e.g., SGSN or UE) that communicates message to another electronic communication device (e.g., UE or SGSN), and that perform operations as disclosed herein according to some embodiments.

The electronic communication device 1200 includes a message generation module 1200 and a message communication module 1202. The message generation module 1200 generates a message containing an integrity mode bit and an integrity protection bit. The integrity protection bit indicates whether a Frame Check Sequence (FCS) field of the message has been replaced by a Medium Access Control (MAC) field. The integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid. The message communication module 1202 communicates the message through a network interface toward the other electronic communication device via the telecommunications system.

### Further Definitions and Embodiments

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1-36. (canceled)

37. A method by an electronic communication device of a telecommunications system, the method comprising:
receiving a message containing an integrity mode bit and an integrity protection bit from another electronic communication device;
determining whether the integrity protection bit indicates that a Frame Check Sequence (FCS) field of the message has been replaced by a Medium Access Control (MAC) field; and
responsive to determining that the integrity protection bit indicates that the FCS field has been replaced by the MAC field:
determining whether the MAC field is valid;
responsive to determining that the MAC field is not valid and the integrity mode bit having a first defined value, discarding the message; and
responsive to determining that the MAC field is not valid and the integrity mode bit having a second defined value, providing content of the message to a higher network protocol layer for processing.

38. The method of claim 37, wherein determining whether the integrity protection bit indicates that a FCS field has been replaced by a MAC field comprises determining that the FCS field has been replaced by the MAC field responsive to the integrity protection bit being logic 1.

39. The method of claim 37, wherein the integrity protection bit indicates whether a three octet long FCS field has been replaced by a four octet long MAC field.

40. The method of claim 37, further comprising determining a location of the integrity mode bit in the message based on a defined location where a protection mode bit is contained in another message receivable by the electronic communication device from the other electronic communication device.

41. The method of claim 37, wherein the first defined value is logic 1 and the second defined value is logic 0.

42. The method of claim 37, wherein:
the determining whether the integrity protection bit indicates that a FCS field has been replaced by a MAC field and the determining whether the MAC field is valid are both performed by a Layer 3 of a OSI network protocol stack of the electronic communication device; and
the providing content of the message to a higher network protocol layer comprises providing the content of the message to a higher layer of the OSI network protocol stack.

43. The method of claim 42, wherein the higher layer of the OSI network protocol stack is Layer 4.

44. The method of claim 37, wherein the electronic communication device comprises a user equipment.

45. The method of claim 37, wherein the electronic communication device comprises a Serving GPRS Support Node.

46. An electronic communication device of a telecommunications system, the electronic communication device comprising:
a receiver configured to receive a message containing an integrity mode bit and an integrity protection bit from another electronic communication device;
processing circuitry connected to the receiver and configured to:
determine whether the integrity protection bit indicates that a Frame Check Sequence (FCS) field has been replaced by a Medium Access Control (MAC) field; and
responsive to determining that the integrity protection bit indicates that the FCS field has been replaced by the MAC field:
determine whether the MAC field is valid;
responsive to determining that the MAC field is not valid and the integrity mode bit having a first defined value, discard the message; and
responsive to determining that the MAC field is not valid and the integrity mode bit having a second defined value, provide content of the message to a higher network protocol layer for processing.

47. The electronic communication device of claim 46, wherein determining whether the integrity protection bit indicates that a FCS field has been replaced by a MAC field comprises determining that the FCS field has been replaced by the MAC field responsive to the integrity protection bit being logic 1.

48. The electronic communication device of claim 46, wherein the integrity protection bit indicates whether a three octet long FCS field has been replaced by a four octet long MAC field.

49. The electronic communication device of claim 46, wherein the processing circuitry is configured to determine a location of the integrity mode bit in the message based on a defined location where a protection mode bit is contained in another message receivable by the electronic communication device from the other electronic communication device.

50. The electronic communication device of claim 46, wherein:
the determining whether the integrity protection bit indicates that a FCS field has been replaced by a MAC field and the determining whether the MAC field is valid are both performed by a Layer 3 of a OSI network protocol stack of the electronic communication device; and
the providing content of the message to a higher network protocol layer, comprises providing the content of the message to a higher layer of the OSI network protocol stack.

51. A method by an electronic communication device of a telecommunications system, the method comprising:
generating a message containing an integrity mode bit and an integrity protection bit, wherein the integrity protection bit indicates whether a Frame Check Sequence (FCS) field of the message has been replaced by a Medium Access Control (MAC) field, and the integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid; and
communicating the message toward the other electronic communication device through the telecommunications system.

52. The method of claim 51, wherein the integrity protection bit is set to logic 1 to indicate that the FCS field has been replaced by the MAC field.

53. The method of claim 51, wherein the integrity protection bit indicates whether a three octet long FCS field has been replaced by a four octet long MAC field.

54. The method of claim 51, wherein generating the message comprises defining a value of the integrity mode bit at a location in the message that corresponds to a location where a protection mode bit is contained in another message communicated to the other electronic communication device.

55. The method of claim 51, wherein the first defined value is logic 1 and the second defined value is logic 0.

56. The method of claim 51, wherein the electronic communication device comprises a user equipment.

57. The method of claim 51, wherein the electronic communication device comprises a Serving GPRS Support Node.

58. An electronic communication device of a telecommunications system, the electronic communication device comprising:
a network interface configured to communicate message toward another electronic communication device through the telecommunications system;
processing circuitry connected to the network interface and configured to:
generate a message containing an integrity mode bit and an integrity protection bit, wherein the integrity protection bit indicates whether a Frame Check Sequence (FCS) field of the message has been replaced by a Medium Access Control (MAC) field, and the integrity mode bit indicates whether another electronic communication device receiving the message is to discard the message responsive to determining that the MAC field is not valid or is to provide content of the message to a higher network protocol layer of the another electronic communication device for processing responsive to determining that the MAC field is not valid; and
communicate the message through the network interface toward the other electronic communication device.

59. The electronic communication device of claim 58, wherein the integrity protection bit indicates whether a three octet long FCS field has been replaced by a four octet long MAC field.

60. The electronic communication device of claim 58, wherein generating the message comprises defining a value of the integrity mode bit at a location in the message that corresponds to a location where a protection mode bit is contained in another message communicated to the other electronic communication device.
